(19) United States
(12) Patent Application Publication
(10) Pub. No.: US 2019/0009494 A1
(43) Pub. Date: Jan. 10, 2019

(54) STRUCTURAL LAMINATE PANEL WITH INTERNALLY ROUTED COMPONENTS

(71) Applicant: WESTHILL INNOVATION INC., Simcoe (CA)

(72) Inventors: Emil RADOSLAV, Dundas (CA); Kevin WEILER, Palmerston (CA); Daniel RADOSLAV, Dundas (CA)

(21) Appl. No.: 16/028,071

(22) Filed: Jul. 5, 2018

Related U.S. Application Data
(60) Provisional application No. 62/529,675, filed on Jul. 7, 2017.

(51) Int. Cl. B32B 3/10; B32B 3/26

(52) U.S. Cl. CPC B32B 3/10; B32B 2605/00; B32B 2607/00; B32B 3/266

(57) ABSTRACT

A structural laminate panel includes: a core member having a perimeter separating opposing first and second side surfaces, the core member formed from a core material including a fiber and a binder; a first reinforcing skin member affixed to the first side surface of the core member; a second reinforcing skin member affixed to the second side surface of the core member; and a cavity defined in the core member, the cavity configured to receive an embedded component of the structural laminate panel.

### CROSS-REFERENCE TO RELATED APPLICATIONS

This application claims priority from U.S. Provisional Patent Application No. 62/529675, filed Jul. 7, 2017, the contents of which is incorporated herein by reference.

### FIELD

The specification relates generally to structural laminates, and specifically to structural laminate panels with internally routed components.

### BACKGROUND

Various structures, such as shipping containers, transport trailers and the like, include lighting (e.g. interior and/or exterior lights), electrical pneumatic or hydraulic components (e.g. to operate doors, locks, etc.), and the like. Such components may be supplied from a first location in or near the structure, such as a generator, engine, or the like (e.g. in a tractor unit of a tractor-trailer), but may be placed at a second location in or on the structure. The structure therefore typically requires conduits extending between the supply and the components themselves. Additionally, the structure may require additional hardware to affix the components to surfaces of the structure (e.g. walls or doors of a trailer). The conduits mentioned above, as well as the mechanisms employed to attach the components to surfaces, may be prone to damage or tampering, impeding operation of the components.

### SUMMARY

An aspect of the specification provides a structural laminate panel including: a core member having a perimeter separating opposing first and second side surfaces, the core member formed from a core material including a fiber and a binder; a first reinforcing skin member affixed to the first side surface of the core member; a second reinforcing skin member affixed to the second side surface of the core member; and a cavity defined in the core member, the cavity configured to receive an embedded component of the structural laminate panel.

### BRIEF DESCRIPTIONS OF THE DRAWINGS

Embodiments are described with reference to the following figures, in which:

FIGS. 1A and 1B depict front and rear perspective views of a structural laminate panel;

FIG. 2 depicts an exploded view of the panel of FIGS. 1A and 1B;

FIG. 3 depicts an isometric view of the panel of FIG. 1A with a skin member removed;

FIG. 4 depicts a partial cross section taken along the line F4-F4 of FIG. 3;

FIGS. 5A, 5B and 5C illustrate example cavity structures in the panel of FIGS. 1A and 1B;

FIG. 6 depicts an example implementation of the panel of FIGS. 1A and 1B;

FIG. 7 depicts an exploded view of a panel according to another embodiment; and

FIG. 8 depicts a cross section of a panel core member according to a further embodiment.

### DETAILED DESCRIPTION

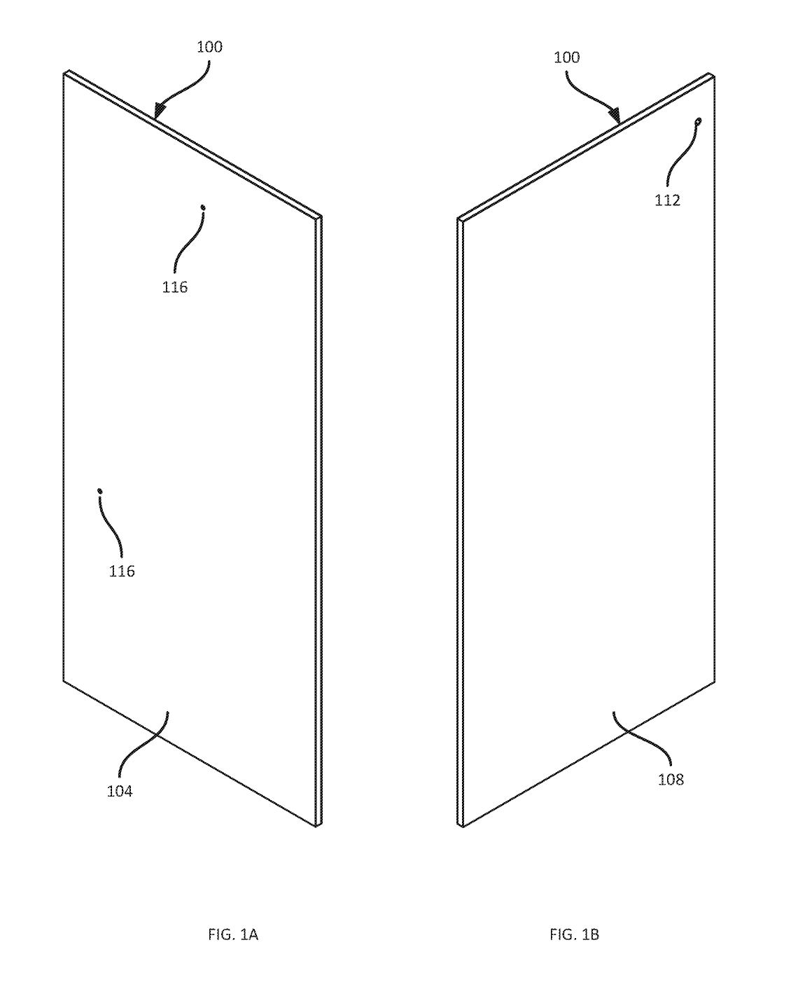

FIGS. 1A depict a structural laminate panel 100. In the present example, the panel 100 is one of a matched pair of rear door panels for a transport trailer (not shown). Specifically, FIG. 1A depicts an outer surface 104 of the panel 100, configured to face the exterior of the trailer when the panel 100 is installed, while FIG. 1B depicts an inner surface 108 of the panel 100, configured to face the interior of the trailer when the panel 100 is installed.

In other examples, the panel 100 may be implemented as any of a wide variety of other structural panels, including walls and/or ceilings for transport trailers. Further examples of structural panels having the features discussed below in connection with the panel 100 are portable buildings, shipping containers, prefabricated building modules, and the like. As will be apparent, the size and dimensions of such panels may differ from those of the panel 100, according to the application for which the panels are to be deployed. The panel 100, in the present example, has a height of about 2.5 meters (about 100 inches) and a width of about 1.2 meters (about 48 inches).

As will be discussed in greater detail below, the panel 100 includes one or internal cavities, not visible in FIGS. 1A and 1B, for carrying conduits and other components. Certain of the above-mentioned conduits can be configured to receive compressed air, electricity or the like from a source inside the trailer and deliver the compressed air, electricity or the like to the exterior of the trailer. To that end, the panel 100 as illustrated includes an inlet aperture 112 (see FIG. 1B) and outlet apertures 116 (see FIG. 1A) that each communicate with at least one of the cavities (i.e, connect the cavities with the interior of the trailer in the case of the inlet 112, and with the exterior of the trailer in the case of the outlets 116). In some examples, one or more of the cavities need not be connected to such apertures.

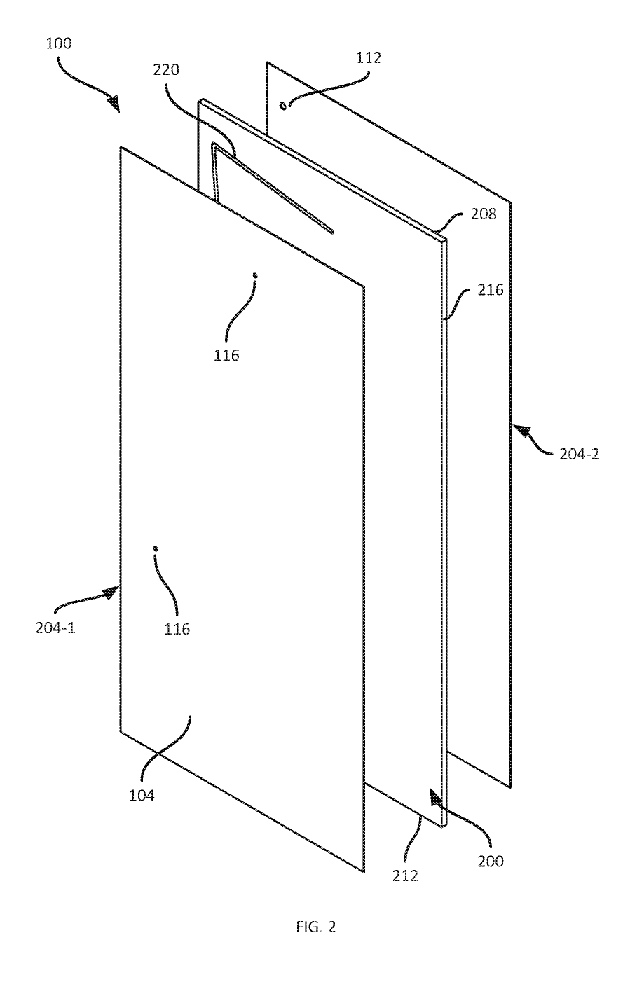

Turning to FIG. 2, an exploded view of the panel 100 is shown. As seen in FIG. 2, the panel 100 includes a core member 200, a first, or outer, reinforcing skin member 204-1 and a second, or inner, reinforcing skin member 204-2. The skin member 204-1 defines the apertures 116 and the outer surface 104, while the skin member 204-2 defines the aperture 112 and the inner surface 108.

The skin members 204 are affixed to the core member 200 via a suitable adhesive (not shown in FIG. 2), which may be sprayed, rolled or the like, onto the core member 200 during manufacture of the panel 100. As illustrated, each of the skin members 204 extends over substantially the entirety of a corresponding side surface of the core member 200.

The panel 100, as noted above, has a generally rectangular shape in the illustrated example. The core member 200 thus includes a rectangular perimeter dividing the inner and outer surfaces 108 and 104. The perimeter, in the present example, includes an upper edge 208 and an opposing lower edge 212, which are substantially parallel to each other. The perimeter also includes substantially parallel opposing side edges 216 (one of which is visible in FIG. 2). As seen in FIG. 2, the upper and lower edges 208 and 212 are substantially perpendicular to the side edges 216. The skin members 204 have substantially the same shape as the core member 200. In other examples, however, the panel 100 can take any of a variety of shapes, and therefore need not include a perimeter defined by pairs of parallel edges as shown in FIG. 2.

The core member 200 and the skin members 204 together provide structural functionality for the panel 100, supporting the panel 100 itself (e.g. in conjunction with other panels) and any components mounted thereon. More specifically, the skin members 204 may provide bending resistance to the core member 200, while the core member 200 resists compressive loads.

The core member 200 is fabricated from a composite material including at least a fiber and a binder. The fiber can include recycled materials (e.g. waste materials from other processes) such as rice husk, wood chips or fibers, carpet core and/or carcass, or the like. The fiber can also include, instead of or in addition to recycled materials, virgin materials (including any of the above-mentioned fibers). The fiber can include any suitable combination of natural and synthetic fibers; further examples of the fiber include nylon, polyethylene terephthalate (PET), polypropylene, and the like. The binder includes any of a variety of suitable binding agents, such as thermosetting polymers (e.g. polyurethane, polypropylene), thermoplastic polymers (e.g. polyvinyl chloride (PVC), polyethylene (PE)) and the like. The core member 200 can also include suitable additives, such as a foaming agent to reduce the density of the core member 200, stabilizing agents, coloring agents, fire retardants, and the like.

The skin members 204 are metallic in the present embodiment. In particular, each skin member 204 is a sheet of steel (e.g. stainless steel, although any of a wide variety of steels may be employed, including galvanized steel, painted steel and the like). In other embodiments, the skin members 204 can be sheets of aluminum or other suitable metals (e.g. titanium). In still other embodiments, the skin members 204 can be fabricated from other suitable reinforcing materials, such as a carbon fiber composite, Kevlar or the like. The skin members 204 can also include, in some embodiments, one or more coatings, e.g. to enhance binding of the above-mentioned adhesives, to inhibit corrosion, or the like. The skin members 204 are illustrated as planar members, but in other embodiments can also be corrugated.

Further examples of the composition of the core member 200 and the skin members 204 may be found in Canadian Patent No. 2564406, the contents of which is incorporated herein by reference.

The panel 100 can have various configurations and sizes, based on the application for which the panel 100 is intended. An example panel 100 for use as a rear door of a transport trailer, as mentioned above, can include a core member 200 with a thickness (i.e. the dimension between the skin members 204) of about 6 mm to about 100 mm (about 0.25 inches to about 4 inches). The skin members 204 can each have a thickness of about 0.5 mm to about 2.25 mm (about 0.02 inches to about 0.09 inches).

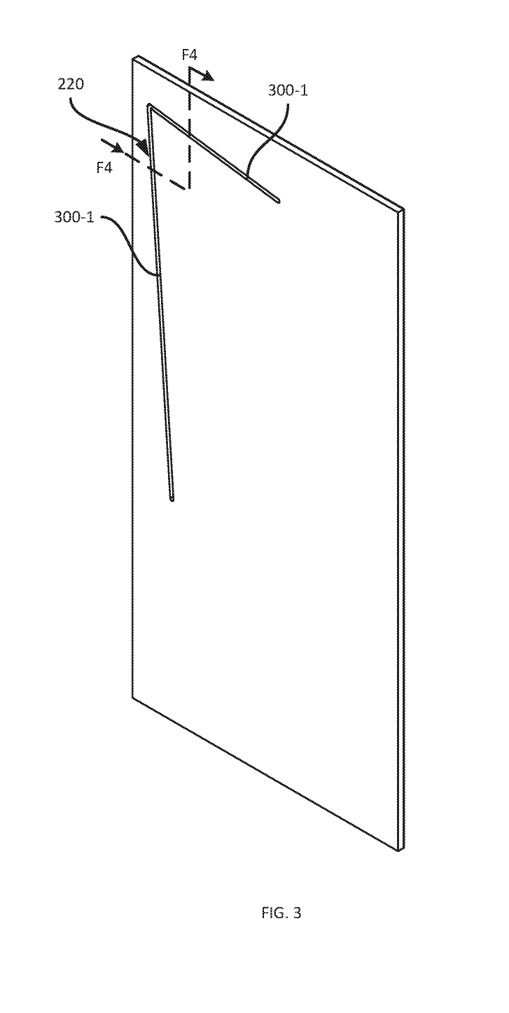

Also shown in FIG. 2 is a cavity 220 cut into the core member 200. Turning to FIG. 3, the panel 100 is shown with the outer skin 204-1 removed to reveal the cavity 220. In particular, the cavity 220 is implemented as a pair of channels 300-1, 300-2 extending between a common entry point into the core member 200 (via the inlet 112) and distinct exit points from the core member 200 (via the outlets 116). The channels 300, in the present example, are configured to receive conduits, such as pneumatic hoses, to supply pressurized air originating inside the trailer to one or more assemblies mounted to the exterior of the panel 100, and/or electrical wiring to deliver electrical power to such assemblies. Such assemblies can include deployable aerodynamic fins, as will be discussed in greater detail below. Various other forms of conduit can be embedded within the panel 100 via the channels 300 or other suitable conduits (not shown) in the core member 200. Such conduits include electrical wiring to supply electrical power, receive electrical power (e.g. from solar panels mounted on the exterior of the panel 100) convey data signals, or both. Such conduits also include cooling or heating fluid lines, hydraulic fluid lines, and the like.

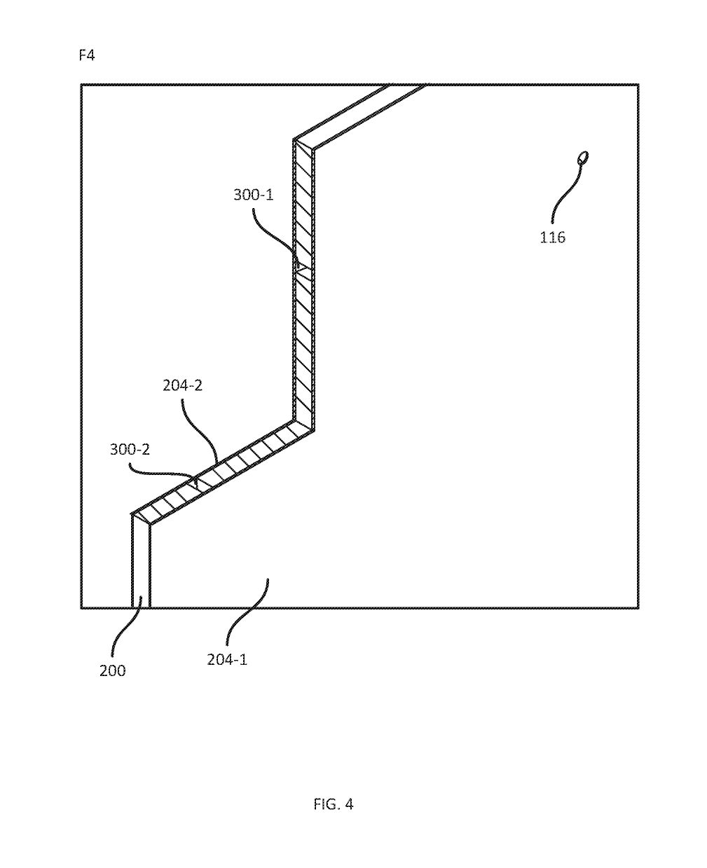

FIG. 4 illustrates a cross section taken at the line F4-F4 as indicated in FIG. 3. As shown in FIG. 4, the channels 300 extended through the core member 200, from one skin member 204 to the other. In other examples, the channels 300 (or any other suitable cavity defined within the core member 200) need not extend through the entire thickness of the core member 200. Instead, a cavity can extend from either side of the core member 200 to an interior position of the core member. In further examples, a cavity can extend from the perimeter (e.g. from a side edge 216) into the core member 200, without interrupting either the inner or outer surfaces of the core member 200. It is contemplated that any given panel 100 can include any suitable combination of the above-mentioned cavity configurations, selected according to the components to be embedded in the panel. The size of each cavity (e.g. the inner diameter of the channels 300 is selected according to the component to be embedded therein. For example, the channels 300 can be sized to movably receive the above-mentioned air hoses, to permit removal and replacement of the air hoses through the apertures 112 and 116 following assembly of the panel 100. In other examples, the channels 300 can be sized to grip the air hoses to prevent their removal following assembly of the panel 100.

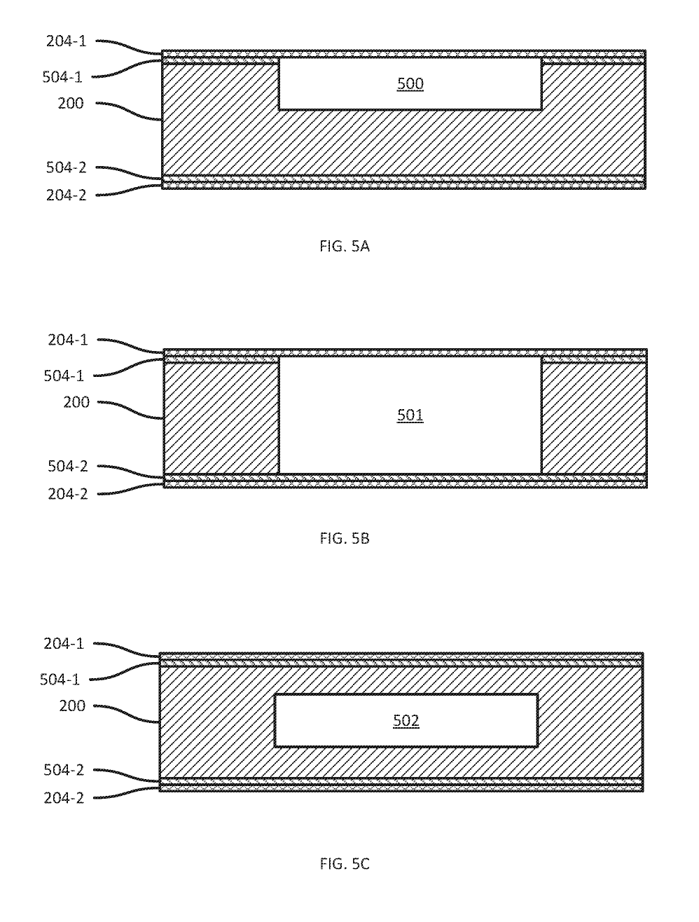

Turning to FIGS. 5A, 5B and 5C, examples of the above-mentioned cavity structures are shown as partial cross sections. In particular, FIG. 5A illustrates a cavity 500 extending from one side of the core member 200 (adjacent to the skin 204-1) to an interior portion of the cavity member 200. FIG. 5B illustrates a cavity 500 extending through the entire thickness of the core member 200, from the skin 204-1 to the skin 204-2. FIG. 5C, meanwhile, illustrates a cavity 502 located within the interior of the core member 200 (i.e. that does not extend out to either of the skin members 204). Also shown in FIGS. 5A-5C are adhesive layers 504-1 and 504-2 bonding the skin members 204-1 and 204-2, respectively, to the core member 200.

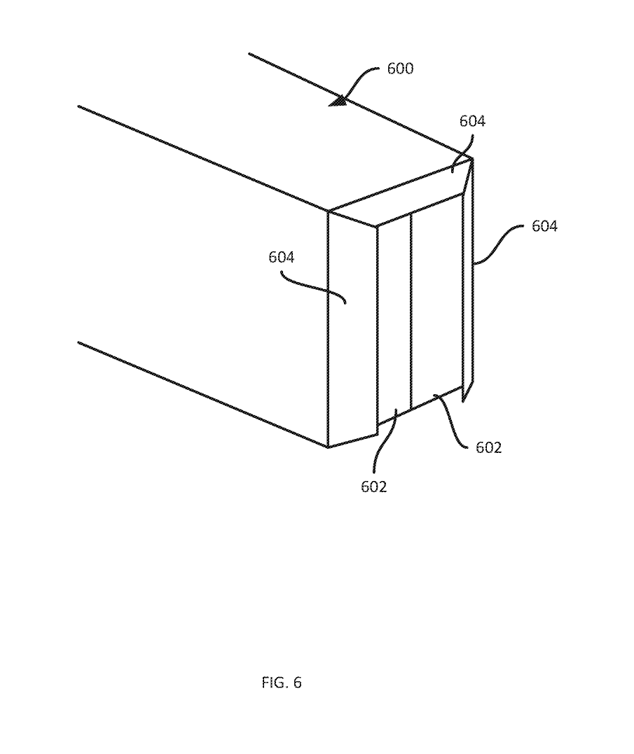

Referring to FIG. 6, an example deployment of the panel 100 is shown. As noted above, the channels 300 can be employed to embed air hoses within the core member 200 to receive compressed air from a source within a transport trailer 600 (of which a rear portion thereof is shown in FIG. 6) or other structure, and to deliver the compressed air to one or more pneumatic actuators mounted to the exterior of trailer doors 602 and configured to deploy and retract one or more aerodynamic fins 604 (which may also be referred to as fairings). As noted above, in other embodiments electrical conduits can be employed to supply power to electrical actuators for deploying and retracting the fins 604. Each trailer door 602 can be fabricated from a panel 100 as discussed above. For example, a panel 100 may be provided with the channels 300 as noted earlier, as well as a plurality of cavities adjacent to and communicating with a side edge 216 to receive hinge assemblies for coupling the door to the trailer 600. Each panel 100 may also be fitted with a perimeter gasket (not shown) to seal the door against the walls of the trailer 600 when the door is closed.

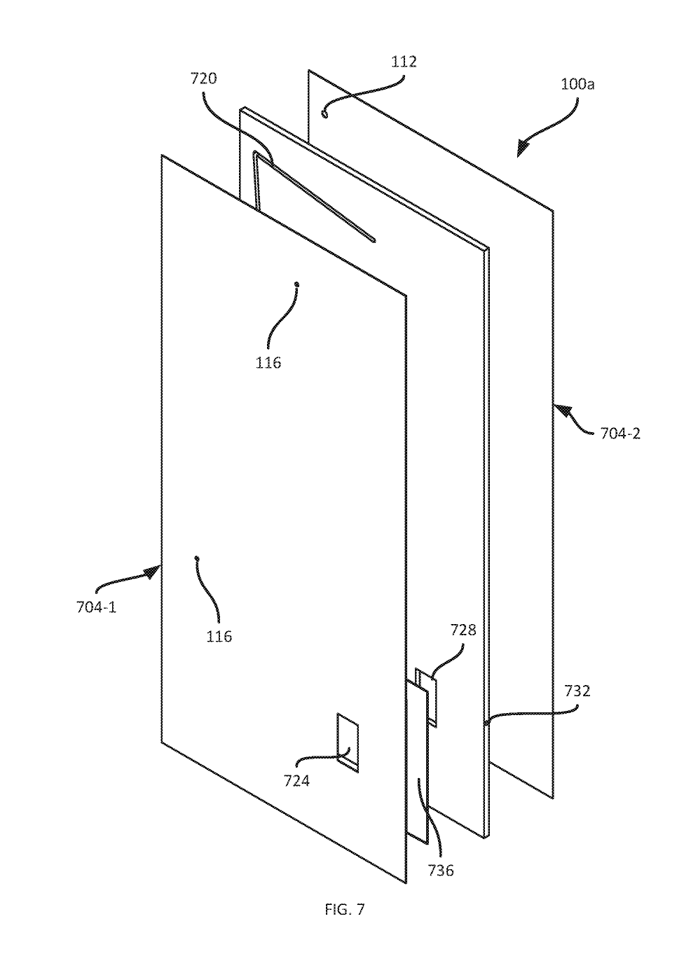

Various other components, instruments or the like beyond the above-noted conduits can be embedded in the core member 200. For example, any one of, or any suitable combination of, batteries, controllers (e.g. circuit boards and the like) can be embedded in the core member 200 via one or more cavities. A further example of a component embedded in the core member 200 is a lock assembly, e.g. for the doors 602 shown in FIG. 6. For example, turning to FIG. 7, a panel 100a is shown including a core member 700 and skin members 704-1, 704-2. The core member 700 and skin members 704 are as described above in connection with the panel 100, except as noted below. The skins 704 therefore define apertures 712 and 716, and the core member 700 includes a cavity 720 configured to receive conduits such as air hoses, as noted earlier.

The panel 100a also includes, in contrast to the panel 100, an additional aperture 724 in the outer skin 704-1 permitting communication between the exterior of the panel 100a and a further cavity 728 defined in the core member 700, The cavity 728 may be of the form shown in either of FIGS. 5A or 5B. Further, the core member 700 includes an additional cavity 732 of the form shown in FIG. 5C, connecting the perimeter (specifically, a side edge) of the core member 700 with the cavity 728. The cavity 728 can contain an embedded locking assembly, and the cavity 732 can receive a movable bolt or other locking mechanism extending from the locking assembly to the trailer frame or another panel (i.e. the other door of the trailer). The aperture 724, meanwhile, can permit access to a control panel, keyhole or the like of the locking assembly.

The panel 100a also includes an auxiliary reinforcing sheet 736 bonded between the skin 704-1 and the core member 700 around the aperture 724 and the cavity 728. The auxiliary reinforcing sheet 736 can be fabricated from Kevlar or any other suitable material configured to inhibit tampering with the locking assembly. In the illustrated example, the auxiliary reinforcing sheet 736 extends only over a portion of the area of the core member 700. In other examples, the auxiliary reinforcing sheet 736 can extend across the entire surface of the core member 700 (i.e. the auxiliary reinforcing sheet 736 can have the same shape as the skin members 704). In further examples, a second auxiliary reinforcing sheet (not shown) can be placed between the second skin 704-2 and the core member 700.

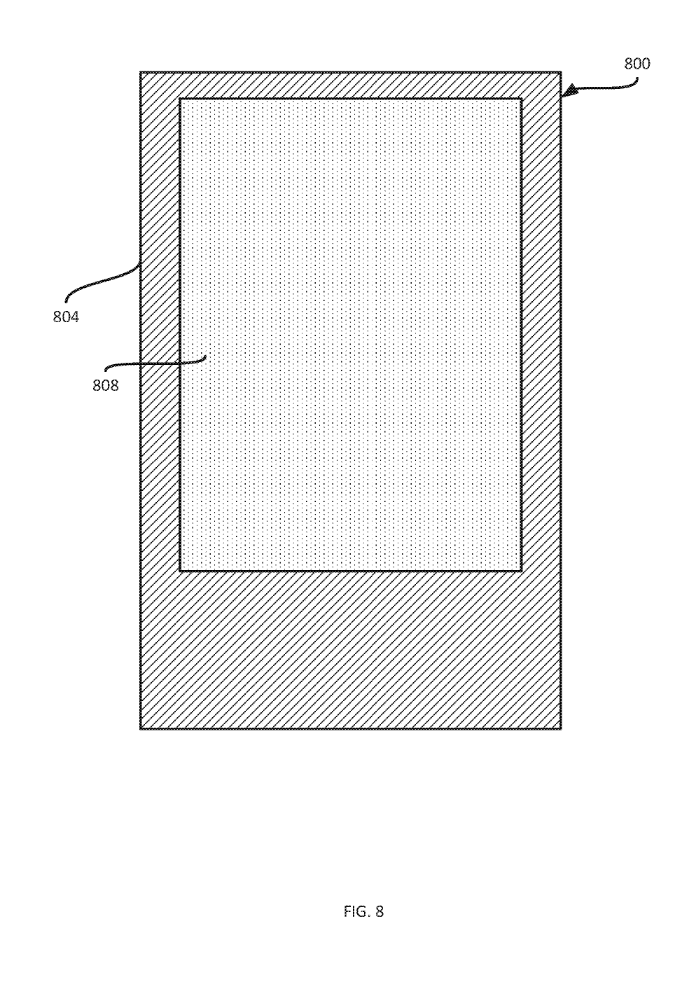

Further variations to the panels described above are contemplated. For example, turning to FIG. 8, a cross-section of a core member 800 is shown. The core member 800 includes a first portion 804 composed of a core material as described above, and a second portion 808 composed of a secondary core material having a lower density than the core material forming the portion 804. One or both of the portions 804 and 808 can include cavities for receiving embedded components. For example, the denser portion 804 can include cavities for receiving the above-mentioned hinges, lock assemblies and the like, while the less dense portion 808 can include channels for receiving conduits (such as the above-mentioned air lines). The nature of the secondary core material is not particularly limited. For example, a foam, honeycomb structure or the like can be employed for the portion 808.

A method of fabricating the panels described above is also contemplated. For example, fabrication of the panel 100 can be initiated by fabricating the core member (e.g. via extrusion, batchwise molding, or the like of the core material). Prior to adhesion of at least one of the skin members 204 to the core member 200 (i.e. when neither skin member 204 has been bonded to the core member 200, or when only one of the skin members 204 has been bonded), the cavities of the core member 200 are routed, drilled or the like into the core member 200. The embedded components can also be placed into respective cavities prior to placement of the final skin member 204. Further, in some examples, the panel can be fabricated with additional mechanisms such as the above-mentioned deployable fins preassembled, In such examples, following placement of both skin members 204, the fins or other components (including door gaskets and the like) may be affixed to the panel 100.

The scope of the claims should not be limited by the embodiments set forth in the above examples, but should be given the broadest interpretation consistent with the description as a whole.

1. A structural laminate panel, comprising:
a core member having a perimeter separating opposing first and second side surfaces, the core member formed from a core material including a fiber and a binder;
a first reinforcing skin member affixed to the first side surface of the core member;
a second reinforcing skin member affixed to the second side surface of the core member; and
a cavity defined in the core member, the cavity configured to receive an embedded component of the structural laminate panel.

2. The structural laminate panel of claim 1, further comprising at least one additional cavity configured to receive at least one additional embedded component of the structural laminate panel.

3. The structural laminate panel of claim 1, wherein the cavity extends through the core member.

4. The structural laminate panel of claim 1. wherein the cavity extends from one of the first and second side surfaces to an interior of the core member.

5. The structural laminate panel of claim 1, wherein the cavity defines a channel, and wherein the embedded component is a conduit for mounting within the channel.

6. The structural laminate panel of claim 5, wherein the conduit includes one o ore of a pneumatic hose, an electrical wire, and a hydraulic line.

7. The structural laminate panel of claim 1. wherein the cavity defines a chamber, and wherein the embedded component includes at least one of a lock assembly, a hinge, a battery, and a circuit board.

8. The structural laminate panel of claim 7, wherein the embedded component is a lock assembly, and wherein the chamber extends to the perimeter for permitting extension and retraction of a locking bolt of the lock assembly from the structural laminate panel.

9. The structural laminate panel of claim 8, further comprising an auxiliary reinforcing sheet between the core member and at least one of the first and second skin members.

10. The structural laminate panel of claim 1, further comprising an aperture defined through at least one of the first and second skin members for communicating with the cavity.

11. The structural laminate panel of claim 1. wherein the core member comprises a first portion formed from the core material, and a second portion formed from a secondary core material having a lower density than the core material.

12. The structural inate panel of claim 11, wherein the cavity is defined in the core material.

13. The structural laminate panel of claim 12, further comprising a secondary cavity defined in the secondary core material.

14. The structural laminate panel of claim 1, wherein the panel forms one of a door, a roof panel, and a wall panel.

15. The structural inate panel of claim 14, wherein the panel forms a trailer door.
